(19) United States
(12) Patent Application Publication
(10) Pub. No.: US 2021/0319019 A1
(43) Pub. Date: Oct. 14, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Yusuke TAMURA, Kanagawa (JP)

(73) Assignee: FUJIFILM BUSINESS CORPORATION, Tokyo (JP)

(21) Appl. No.: 17/132,894

(22) Filed: Dec. 23, 2020

(30) Foreign Application Priority Data
Apr. 13, 2020 (JP) 2020-071962

(51) Int. Cl. G06F 16/242

(52) U.S. Cl. CPC G06F 16/2425

(57) ABSTRACT

An information processing apparatus includes a processor configured to display a screen for specifying one or more search conditions of a search. The screen presents one or more search histories. Each search history of the one or more search histories presents one or more previous search conditions used for a previous search, together with an attribute of a file on which a user performed an operation following the previous search.

### CROSS-REFERENCE TO RELATED APPLICATIONS

This application is based on and claims priority under 35 USC 119 from Japanese Patent Application No. 2020-071962 filed Apr. 13, 2020.

### BACKGROUND

### (i) Technical Field

The present disclosure relates to an information processing apparatus and a non-transitory computer readable medium.

### (ii) Related Art

To access an intended file, a search condition is designated to search files in the file system. Various measures are devised to efficiently search the files.

Japanese Unexamined Patent Application Publication No. 2004-310462 discloses an information summary creation device that assists a searcher in the following manner in determining whether an intended document is included in the search result. The information summary creation device holds the input history of search words used for searching and search result documents, analyzes the input history of the search words, summarizes the search result documents by using a document summarization method decided on the basis of the analysis result, and presents summaries to the searcher.

A search history is also presented, and thereby the user is assisted in selecting a search condition for a new search to be executed next.

### SUMMARY

Aspects of non-limiting embodiments of the present disclosure relate to providing a system that assists a user to find a search history the user may want to use again for a new search by providing the user not only with a search condition that was used for a previous search, but also with some additional information.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a processor configured to display a screen for specifying one or more search conditions of a search. The screen presents one or more search histories. Each search history of the one or more search histories presents one or more previous search conditions used for a previous search, together with an attribute of a file on which a user performed an operation following the previous search.

### BRIEF DESCRIPTION OF THE DRAWINGS

An exemplary embodiment of the present disclosure will be described in detail based on the following figures, wherein:

FIG. 1 is a diagram illustrating the overall configuration of a file management system according to this exemplary embodiment;

FIG. 2 is a diagram illustrating the functional configuration of a file management server;

FIG. 3 is a diagram illustrating an example hardware configuration of the file management server;

FIG. 4 is a diagram illustrating the functional configuration of a client terminal;

FIG. 5 is a diagram illustrating an example hardware configuration of the client terminal;

FIG. 6 is a view illustrating an example configuration of a search screen;

FIG. 7 is a view illustrating an example configuration of a display screen for a search history; and

FIG. 8 is a view illustrating the search history display screen displayed after the search history statements are narrowed down.

### DETAILED DESCRIPTION

Hereinafter, an exemplary embodiment of the present disclosure will be described in detail with reference to the attached drawings.

### Overall Configuration

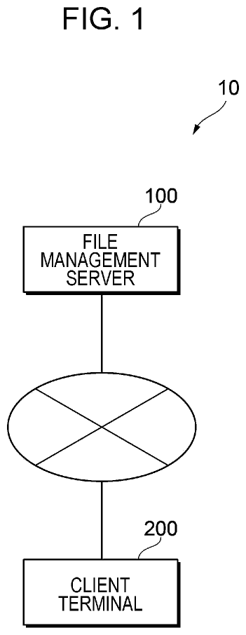

FIG. 1 is a diagram illustrating the overall configuration of a file management system of this exemplary embodiment. A file management system 10 of this exemplary embodiment includes a file management server 100 and a client terminal 200. The file management server 100 and the client terminal 200 are connected via a network.

The file management server 100 is a server that is provided on the network and that searches data files in response to a request from the client terminal 200. Although FIG. 1 illustrates one server, the functions of the file management server 100 may be distributed to servers to implement the file management server 100. The file management server 100 may also be a virtual server implemented by using resources on the network.

The client terminal 200 accesses the file management server 100 via the network. An information processing apparatus such as a personal computer or a tablet terminal is used as the client terminal 200.

The network may be any network usable to exchange data between the file management server 100 and the client terminal 200, and a specific configuration of the network is not particularly limited. For example, a local area network (LAN), a wide area network (WAN), or the Internet may be used as the network. The network as a communication network may be a wired or wireless network.

### Functional Configuration of File Management Server

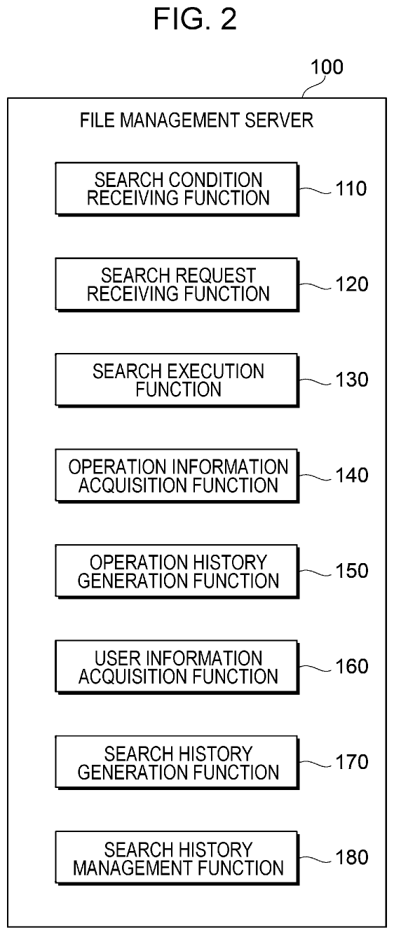

FIG. 2 is a diagram illustrating the functional configuration of the file management server 100. The file management server 100 includes a search condition receiving function 110, a search request receiving function 120, and a search execution function 130. The file management server 100 further includes an operation information acquisition function 140, an operation history generation function 150, and a user information acquisition function 160. The file management server 100 further includes a search history generation function 170 and a search history management function 180. The file management server 100 may search data files stored on the file management server and/or data files stored on a storage server or another apparatus different from the file management server 100.

The search condition receiving function 110 receives a search condition of a search on data files. By using the search condition receiving function 110, the file management server 100 generates, for example, a search screen for receiving an operation by a user and transmits the search screen to the client terminal 200 to display the search screen on the client terminal 200. The search condition receiving function 110 receives a search condition designated (input) by the user from the search screen displayed on the client terminal 200. A keyword, a search location, the attribute of a data file (hereinafter, referred to as a “file attribute”), and the like may be designated as the search condition. In this exemplary embodiment, the file management server 100 also displays, on the search screen, a search history to help the user narrow down a search by using the search condition receiving function 110. The details of the displaying of the search history will be described later.

The search request receiving function 120 receives a request for executing a search for searching data files (hereinafter, also referred to as a “search request”). By using the search request receiving function 120, the file management server 100 receives a search request made by the user on the search screen displayed on the client terminal 200. In this exemplary embodiment, the file management server 100 also uniquely assigns identification information to the search request received by using the search request receiving function 120. The search request assigned the identification information is transmitted to the search execution function 130 together with the search condition.

The search execution function 130 executes the data file search. In accordance with the search request received by using the search request receiving function 120 and the search condition received by using the search condition receiving function 110, the file management server 100 executes the data file search by using the search execution function 130. In this exemplary embodiment, the file management server 100 also assigns, to the search result acquired by using the search execution function 130, the identification information assigned to the search request by using the search request receiving function 120. By using the search execution function 130, the file management server 100 generates a search result display screen for displaying a search result and transmits the search result display screen to the client terminal 200 to display the search result display screen on the client terminal 200.

The operation information acquisition function 140 acquires information regarding an operation performed on the client terminal 200 on data files found by the search (hereinafter, referred to as “operation information”). The search result display screen generated by using the search execution function 130 is displayed by a browser in the client terminal 200. On the browser, the user may perform an operation on the data file acquired as the search result. The information regarding the operation performed on the browser is transmitted to the file management server 100 together with the identification information assigned to the search result by using the search execution function 130 and is received by using the operation information acquisition function 140. The details of operations performed on data files on the client terminal 200 will be described later.

The operation history generation function 150 generates history information regarding an operation performed on the data files found by the search (hereinafter, referred to as an “operation history”). When the operation information acquisition function 140 acquires information about an operation performed on any of the data files presented as the search result, the file management server 100 generates an operation history by using the operation history generation function 150. The file management server 100 compares the identification information acquired by using the operation information acquisition function 140 with the identification information assigned to the search result by using the search execution function 130 and thereby associates the search result with the generated operation history.

The operation history includes information such as the type of an operation performed on a data file, the date and time of the operation, a file name for identifying the data file, and a file attribute of the data file. Examples of the file attribute include creator, creation date, type (category), product, brand name, and status of the data file. For example, in response to an operation for changing the attribute of the data file from “not disclose” to “disclose”, information regarding the attribute after the change (or both before and after the change) is recorded in the operation history.

The user information acquisition function 160 acquires information regarding a user who performed an operation on the data files found by the search (hereinafter, referred to as “user information”). The user information is information for identifying the user. The user information may include not only the identification information of the user themselves but also identification information of the client terminal 200 that was used by the user to execute the search (identification information of the client terminal 200 that was used to make the search request). The user information is acquired from, for example, authentication information input by the user to log in to the file management server 100. If the user authentication is performed by an authentication server outside the file management server 100, the file management server 100 may access the authentication server and thereby acquire the user information by using the user information acquisition function 160.

The search history generation function 170 generates history information regarding a series of events related to the search (hereinafter, referred to as a “search history”). In response to a user performing an operation on any one or more of the data files found by the search, the file management server 100 generates a search history of the search by using the search history generation function 170. Among the data files found by the search, the data files on which a user operation was performed following the search may be hereinafter referred to as “history target files”. The search history includes a search condition of the search, an operation history of the search, user information of the search, and the like.

The search history includes a search condition of the search that found the history target data files). When a plurality of search conditions were used for the search, only a portion of the plurality of search conditions may be selectively recorded in the search history. For example, the search conditions may be prioritized, and only a predetermined number of conditions with high priorities may be recorded in the search history.

The search history may be configured to record (or not to record) a search condition matching a predetermined specific condition. For example, among the search conditions such as a keyword, a search location, and a file attribute set for a search, only search conditions changed from their default settings may be recorded in the search history. For example, an entire cabinet may be set as a default search location (a location to be searched). If a search is executed with a setting of a search location narrowed down from the default search location, information regarding the search location of the search is recorded in the search history. If the search is executed without any setting of a search location narrowed down from the default search location, information regarding the search location of the search is not recorded in the search history.

For another example, all file types may be set, by default, as file types to be searched. If a search is executed with a setting of a specific file type, information regarding the specific file type is recorded in the search history. If the search is executed without a setting of a specific file type, no information regarding the searched file types is recorded in the search history.

The search history records an operation history of one or more operations performed on a history target file. If a plurality of operations are performed on a history target file, operation histories of only a portion of the plurality of operations may be selectively recorded in the search history. For example, the operation history of only the latest (most recent) operation on the history target file may be recorded in the search history.

The file management server 100 may be configured to record, in the search history, only an operation history of any operation performed before an elapse of a predetermined time from the search. In other words, any operation performed after the elapse of the predetermined time is not recorded in the search history. This is based on the following reason. If no time limit is set, and if the user leaves the client terminal 200 with a search result displayed after the search, the file management server 100 has to wait for the user to perform an operation on any of the data files presented as the search result forever. For example, a search history may be generated at the elapse of the predetermined time from the search, so the search history will only include operation histories of operations performed within the predetermined time. When recording only the operation history of the most recent operation, the most recent operation before the elapse of the predetermined time may be recorded in the search history.

The search history records user information of the user who performed an operation on the history target file. Since the user who executed a search (searcher) is most likely to be the user who performed the operation on the history target file, user information of the searcher may be recorded. The user information includes at least one of identification information of the searcher or identification information of the client terminal 200 from which the operation was performed.

The search history management function 180 manages search histories generated by using the search history generation function 170. The file management server 100 holds the search histories in the memory and manages the search histories by using the search history management function 180. In response to a request from the client terminal 200 to display a search screen for receiving search conditions of a new search, the file management server 100 reads out search histories of previous searches to be displayed on the search screen by using the search history management function 180. The file management server 100 then transmits, to the client terminal 200, the search histories by using the search history management function 180 together with the search screen and causes the search histories to be displayed on the search screen on the client terminal 200. The details of the displaying of the search histories will be described later.

### Hardware Configuration of File Management Server

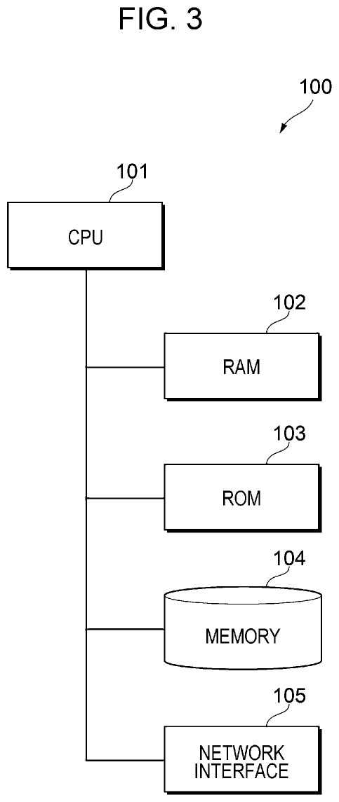

FIG. 3 is a diagram illustrating an example hardware configuration of the file management server 100. The file management server 100 is implemented by a computer. The computer implementing the file management server 100 includes a central processing unit (CPU) 101 that is an arithmetic unit, a random access memory (RAM) 102 that is a memory, a read only memory (ROM) 103, a memory 104, and a network interface 105. The RAM 102 is a main memory and is used as a work memory when the CPU 101 performs computing. The ROM 103 holds programs and data such as set values prepared in advance. The CPU 101 is capable of reading out a program or data directly from the ROM 103 and executing a process. The memory 104 stores the programs and the data. The memory 104 stores the programs, and the CPU 101 loads a program stored in the memory 104 in the RAM 102 that is the main memory and runs the program. The memory 104 also stores the result of the process executed by the CPU 101. As the memory 104, for example, a magnetic disk device, a solid state drive (SSD), or the like is used. The network interface 105 is an interface connected to the network for exchanging data with the client terminal 200.

If the file management server 100 is implemented by the computer illustrated in FIG. 3, the functions of the file management server 100 described with reference to FIG. 2 are implemented, for example, in such a manner that the CPU 101 runs a program. The search histories managed by using the search history management function 180 are stored and held, for example, in the memory 104. In addition, when the file management server 100 holds data files, the data files are stored, for example, in the memory 104.

Functional Configuration of Client Terminal

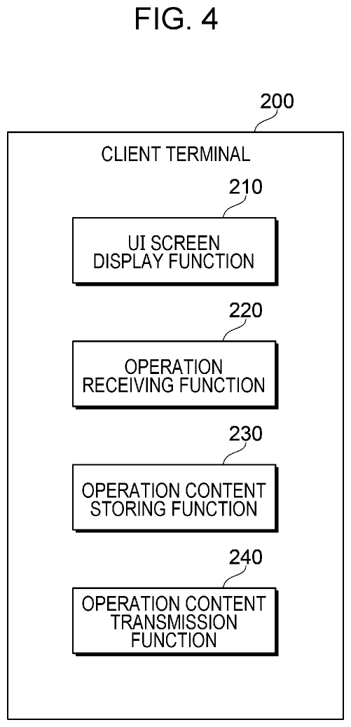

FIG. 4 is a diagram illustrating the functional configuration of the client terminal 200. The client terminal 200 includes a user interface (UI) screen display function 210, an operation receiving function 220, an operation content storing function 230, and an operation content transmission function 240.

The UI screen display function 210 (browser) displays various UI screens on the display screen of the client terminal 200. By using the UI screen display function 210, the client terminal 200 displays a search screen and a search result display screen (examples of UI screens) that are transmitted from the file management server 100. As already mentioned in the description of functional configuration of the file management server 100, the search screen is displayed on the client terminal 200 to receive input of one or more search conditions and a search request. The search result display screen is displayed on the client terminal 200 to present a search result.

By using the UI screen display function 210, the client terminal 200 also displays an operation screen that allows the user to perform further operations on a data file selected from among a plurality of data files presented on the search result display screen. The file management server 100 records, as operation histories, operations performed from the search result display screen and operations performed from the file operation screen. Examples of operations that may be performed on a data file include opening the data file, closing the data file, downloading the data file, editing the data file, and changing an attribute of the data file.

For example, opening and downloading of the data file may be performed on the search result display screen whereas editing of the data file may be performed on the file operation screen. The file operation screen may, for example, be a screen that displays the content of the data file from which the user can make edits to the content. The file operation screen may, for example, be provided by an application program that supports the data file. Opening the data file starts up the application program and displays the content of the data file on the file operation screen. Changing the attribute of the data file may be performed on the search result display screen or the file operation screen, depending on the type of the data file, the application program used to display the data file, or the like.

The client terminal 200 displays the search history on the search screen by using the UI screen display function 210. When inputting a search condition of a new search from the search screen to specify data files to be searched, the user may select a search history from among a plurality of search histories displayed on the search screen. In this exemplary embodiment as described above, the search history of a search includes information regarding an operation performed on a data file presented as a search result of the search. This enables the search history of the search to present not only a keyword used for the search, but also information regarding an operation actively performed by the user after the search. This helps the user to have a better idea of a data file to be found by the search condition presented in the search history. An example of a displayed search history is discussed later.

The operation receiving function 220 receives user operations performed on an input device included in the client terminal 200. By operating the input device, the user inputs a search condition, makes a search request, designates data files, and inputs other information. The client terminal 200 receives the operations by using the operation receiving function 220 and executes a process in accordance with the input request or data.

The operation content storing function 230 stores operation information indicating the content of each operation performed on a data file presented as the search result displayed by using the UI screen display function 210. The client terminal 200 tracks operations performed on the data file and stores acquired operation information by using the operation content storing function 230.

The operation content transmission function 240 transmits the operation information stored by using the operation content storing function 230 to the file management server 100. The client terminal 200 transmits the operation information stored by using the operation content storing function 230 to the file management server 100 by using the operation content transmission function 240. The operation information may be transmitted each time operation information of a new operation is stored. Alternatively, operation information of several operations may be transmitted as a batch. As mentioned earlier in the description of the operation history, the operation history recorded as part of a search history of a search may only include operations performed before an elapse of a predetermined time from the search. In order for the operation history to only include operations performed before an elapse of a predetermined time from the search, the client terminal 200 may be configured to end tracking of operations on the data file at the elapse of the predetermined time from the displaying of the search result and to transmit, to the file management server 100, operation information that have been stored by the time of the elapse of the predetermined time. The earlier description of the operation history has mentioned a search history of a search only recording operation histories of operations performed within a time period between an execution of the search and the elapse of the predetermined time. However, the client terminal 200 may not strictly know when the file management server 100 executes the search. In such case, the operation information of the operations performed within the predetermined time from the displaying of the search result may be transmitted as described above.

### Hardware Configuration of Client Terminal

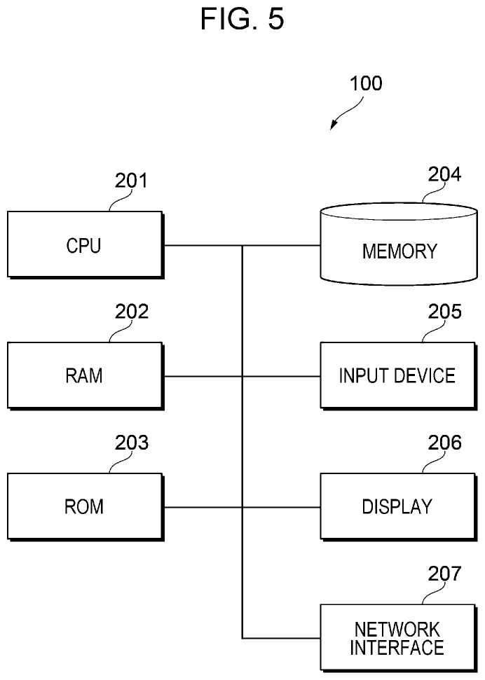

FIG. 5 is a diagram illustrating an example hardware configuration of the client terminal 200. The client terminal 200 is implemented by an information processing apparatus such as a personal computer or a tablet terminal. The information processing apparatus implementing the client terminal 200 includes a CPU 201 that is an arithmetic unit, a RAM 202 that is a memory, a ROM 203, and a memory 204. The computer implementing the client terminal 200 includes an input device 205, a display 206, and a network interface 207. The RAM 202 is a main memory. The CPU 201 is capable of executing a process in such a manner as to read out a program and data from the ROM 203. The memory 204 stores programs. The CPU 201 loads a program stored in the memory 204 into the main memory and runs the program. The memory 204 also stores a result of the process executed by the CPU 201. As the memory 204, for example, a magnetic disk device, a SSD, or the like is used.

The display 206 is a device that displays screens for receiving user operations and screens for presenting information. The display 206 displays a UI screen acquired from the file management server 100. As the display 206, for example, a liquid crystal display or the like is used. The input device 205 receives an input operation performed by the user. The input device 205 receives an operation performed by the user on the operation screen such as the UI screen displayed on the display 206. As the input device 205, for example, a device such as a keyboard or a mouse is used. A touch sensor may also be used as the input device 205, and a touch panel serving as a user interface may thereby be formed in combination with the liquid crystal display that is the display 206. The network interface 207 is an interface connected to the network for exchanging data with the file management server 100.

In the case where the client terminal 200 is implemented by the information processing apparatus illustrated in FIG. 5, the UI screen display function 210 is implemented by, for example, the CPU 201 that runs the program and the display 206. The operation receiving function 220 is implemented by, for example, the CPU 201 that runs the program and the input device 205. The operation content storing function 230 is implemented by, for example, the CPU 201 that runs the program and the memory 204. The operation content transmission function 240 is implemented by, for example, the CPU 201 that runs the program and the network interface 207.

### Displaying Search History

In this exemplary embodiment, each search history of a plurality of displayed search histories presents the search condition of a search together with the attribute or the like of a data file that received a user operation among any data files that were presented as the search result. Specifically, the search condition and the attribute of the data file are included in each displayed search history. In this exemplary embodiment, the displayed search history is in the form of a natural language sentence to facilitate the user understanding of the content of the search history. Hereinafter, an exemplary method for generating a search history in the form of English natural language sentence (hereinafter, referred to as a “search history statement”) will be described.

The search history statement is generated in such a manner that attention is focused on the following elements.

What: an attribute of the data file on which a user operation was performed
When: the date and time of the search
Where: the type of the client terminal 200
Who: an authenticated user
Why: an operation performed on the data file
How: a search condition

The search history statement is generated on the basis of the elements above, for example, as the following sentence. The correlation of the elements is clarified from the structure of a sentence.

“A search was executed on the basis of [When] and [How], and [Why] was performed on [What].
([Who] executed the search from [Where])”
Not all the elements [What], [When], [Where], [Who], [Why], and [How] have necessarily to be used, and some of the elements may be omitted depending on the situation. For example, search histories may be managed on a per-user basis. When displaying search histories of a particular user who is trying to execute a new search, [Who] does not have to be included in the search history statement. For another example, when the user has executed many searches from different apparatuses within a short period of time, providing the user with information on [When] and [Where] may not help the user to recognize the data file the user is trying to find by the new search. In such case, the element [When] and/or [Where] does not have to be included in the search history statement.

Next, an exemplary method of determining information to be included in each element in the search history is described. First, information to be included in [How] (a search condition) is described. Assume a case where a search history indicates a search was executed with the following search conditions set.

Keyword: specifications
File attribute: {creator: Taro Fuji, brand name: XXXver.4.3} Location (search location): whole cabinet (default value) Type (type of data files to search): document only

Pretend that the following predetermined rules are used to select a search condition (or search conditions) to be included in the search history statement.

(1) Among the settable search conditions mentioned above, the order of priority, from the highest to the lowest, is keyword, file attribute, search location, and then type.
(2) The earlier a file attribute is set, the higher the priority is.
(3) Any search condition that was optionally set is not included in the search history statement.
(4) Any search condition that was mandatorily set is not included in the search history statement unless the setting of the search condition was changed from its default setting. Applying the rules to the above-described search conditions leads to the following determination. The keyword “specifications” has the highest priority. Between the two search conditions related to the file attribute, “creator: Taro Fuji” has the higher priority than the priority of “brand name: XXXver.4.3”. Location has a default value and thus is not included in the search history statement. The element [How] (search condition) to be included in the search history statement is thus selected.

Next, information to be included in [What] (the attribute of a data file on which an operation was performed) is described. If there is only one applicable data file, the identification information (such as the file name) of the data file is simply set as [What] (the attribute of the searched data file) to be included in the search history statement. An example of the case where there is only one applicable data file is when an operation was performed only on the data file among data files presented as the search result of the search.

If there is more than one applicable data file, all the applicable data files may be included in the search history statement, or a rule for omitting some of the applicable data files may be predetermined. For example, the search history statement may specify just one of the applicable data files and give the number of the remaining applicable data files by using a format “{the name of one of the applicable data files} and {the number of the remaining applicable data files} other documents”. The one data file may be determined based on a predetermined rule (e.g., the data file matching the search condition to the highest degree). The format and the rule described here are given as an exemplary method for generating the search history statement, and are not intended to be limiting.

Next, information to be included in [Why] (an operation performed on the data file found by the search) is described. As mentioned in the descriptions of the search request receiving function 120 and the search execution function 130 of the file management server 100, the same unique identification information is assigned to a request of a search (including a search condition) and the search result obtained by the search. Therefore, correspondence between the search result and the search condition can be identified, and an operation performed on the data file presented as the search result can also be identified. The operation identified using the above method or the like is included in the search history statement.

Next, information to be included in [When] (the date and time when the search is executed) is described. For example, [When] may be represented by the date and time when the request of the search was issued from the client terminal 200, the date and time when the request of the search was received in the file management server 100, the date and time when a search was executed, the date and time when a search result was transmitted to the client terminal 200, and the like. These dates and times acquired at transmissions of the search request and the search result may be attached to the search history of the search.

Next, information to be included in [Where] (the type of the client terminal 200) is described. For example, [Where] may be represented by information about the client terminal 200 recorded as the user information in the search history, information about the type of the client terminal 200, information about the type of the browser used as the UI screen display function 210 of the client terminal 200, and the like. Specifically, the search history statement may include not only the apparatus name of the client terminal 200 but also a User-Agent header and location information. When information is obtained from the browser, the above-described information may be transmitted, as part of the user information, from the client terminal 200 to the file management server 100, for example, at the transmission of the search request.

Next, information to be included in [Who] (the authenticated user) is described. [Who] may be represented by information regarding the user recorded in the user information in the search history. As described earlier, when search histories are managed on a per-user basis, and when the search histories of a particular user who is trying to execute a new search are displayed, [Who] is not included in the search history statement. However, to extract a search history for generating a search history statement, the information regarding the user is used.

For example, a search condition “specifications” (keyword) may be selected as the information to be included in [How]. The file name

“XXXver.4.3_functional_specifications.pdf” may be selected as the information to be included in [What]. The operation “document disclosure” may be selected as the information to be included in [Why]. The date and time “08/21/2019 15:56” may be selected as the information to be included in [When]. The location “Yokohama, Kanagawa” and the browser “Google Chrome” may be selected as the information to be included in [Where]. Based on these selections, the following search history statement can be generated.
08/21/2019 15:56
Search was executed by using keyword “specifications”, and document disclosure of XXXver.4.3_functional_specifications.pdf was performed (with Google Chrome in Yokohama, Kanagawa)

### Example Configuration of Search Screen

An example configuration of a search screen on which search history statements are displayed will be described. After the search screen is displayed on the client terminal 200 to input a search condition or a search request, a search history (at least one search history statement) is displayed in accordance with an operation performed on the search screen. The search history (search history statement) may be displayed in such a form as a pull-down menu on the search screen, a sub-window of the search screen, or a different screen transitioning from the search screen.

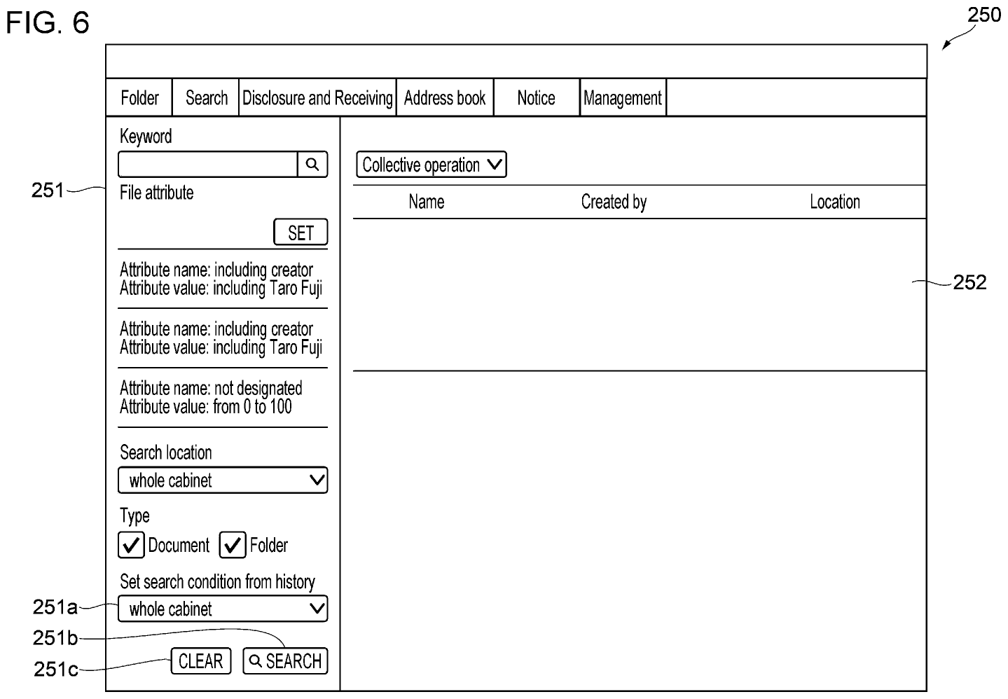

FIG. 6 is a view illustrating an example configuration of the search screen. A search screen 250 illustrated in FIG. 6 has a search condition input area 251 and a search result display area 252 that are displayed thereon. A search result is displayed in the search result display area 252. Accordingly, the search screen 250 illustrated in FIG. 6 also serves as the search result display screen. The search condition input area 251 is provided with input fields for a keyword, a file attribute, a search location (“Search location” in FIG. 6), and the type of a data file (“Type” in FIG. 6). A setting field 251a (“Set search condition from history” in FIG. 6) for a search history, a SEARCH button 251b, and a CLEAR button 251c are displayed in the search condition input area 251.

Settings information for deciding a search history to be displayed may be input in the setting field 251a for a search history. In the example illustrated in FIG. 6, the default value of the settings information is “whole cabinet”. The whole cabinet storing data files to be searched is set as a search range, and thus a search history for the data files is designated. This means that the search history of all of the stored data files may be displayed. When information such as a keyword, a file attribute, a search date and time, a search location, or the type of an operation to be included in the search history is input in the setting field 251a, a search history including the input information is thereby displayed.

The SEARCH button 251b is a button object for transmitting a search request. In response to the input of a search condition by the user (including a setting operation based on a search history) and the operation of the SEARCH button 251b, the search request in addition to the input search condition is transmitted from the client terminal 200 to the file management server 100. The CLEAR button 251c is a button object for erasing (clearing) the input search condition.

### Example Display of Search History

In response to an operation of the setting field 251a for a search history performed on the search screen, search history statements selected on the basis of the condition (hereinafter, referred to as a “setting condition”) input in the setting field 251a is displayed. If there are a plurality of search history statements matching the setting condition, for example, the search history statements are displayed from the latest. If the number of search history statements matching the setting condition is larger than the number of displayable search history statements, the search history statements may be made displayable on the display screen by scrolling the search history statements.

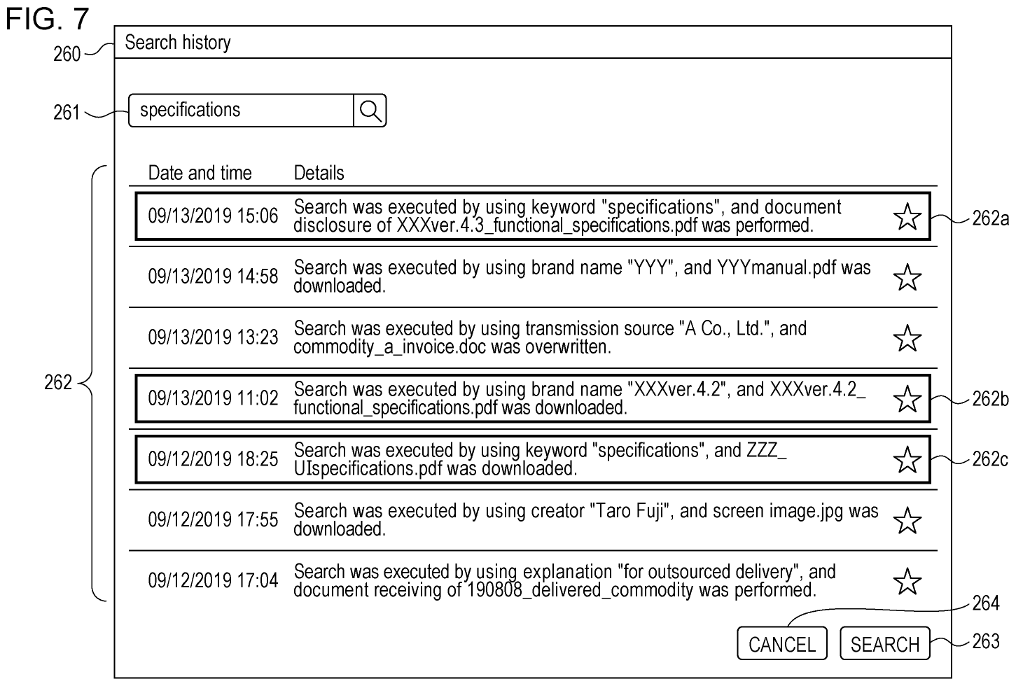

FIG. 7 is a view illustrating an example configuration of a display screen for a search history. A display screen for displaying the search history (hereinafter, a “search history display screen”) 260 illustrated in FIG. 7 has a setting field 261, a search history statement display area 262, a SEARCH button 263, and a CANCEL button 264 that are displayed thereon. Although FIG. 7 illustrates the search history display screen 260 instead of the search screen 250 illustrated in FIG. 6, the search history display screen 260 may be regarded as one of the forms of the search screen 250.

The setting field 261 is used in the same manner as for the setting field 251a of the search screen 250 in FIG. 6. Inputting information to be included in the search history such as a keyword, a file attribute, a search date and time, a search location, or the type of an operation in the setting field 261 on the search history display screen 260 enables search history statements displayed on the search history statement display area 262 to be narrowed down.

By default, the search history statement display area 262 displays any search history statements matching the condition set in the setting field 251a of the search screen 250. The search history display screen 260 illustrated in FIG. 7 is a screen that is displayed when search history statements were searched with no particular settings of conditions in the setting field 251a on the search screen 250 illustrated in FIG. 6. Therefore, the search history statements of the stored search histories are displayed without being filtered in the search history statement display area 262 in FIG. 7.

The SEARCH button 263 is a button object for transmitting a search request. When the user selects any search history statement displayed in the search history statement display area 262 and operates the SEARCH button 263, a search request designating a data file identified by the selected search history statement is transmitted from the client terminal 200 to the file management server 100.

The CANCEL button 264 is a button object for cancelling the data file search. In response to the operation of the CANCEL button 264, the user is directed back to the search screen 250.

Assume that the character string “specifications” is input in the setting field 261. The search history statements displayed in the search history statement display area 262 are narrowed down to search history statements including the character string “specifications”. The character string “specifications” is included in three search history statements 262a, 262b, and 262c displayed on the search history display screen 260 illustrated in FIG. 7.

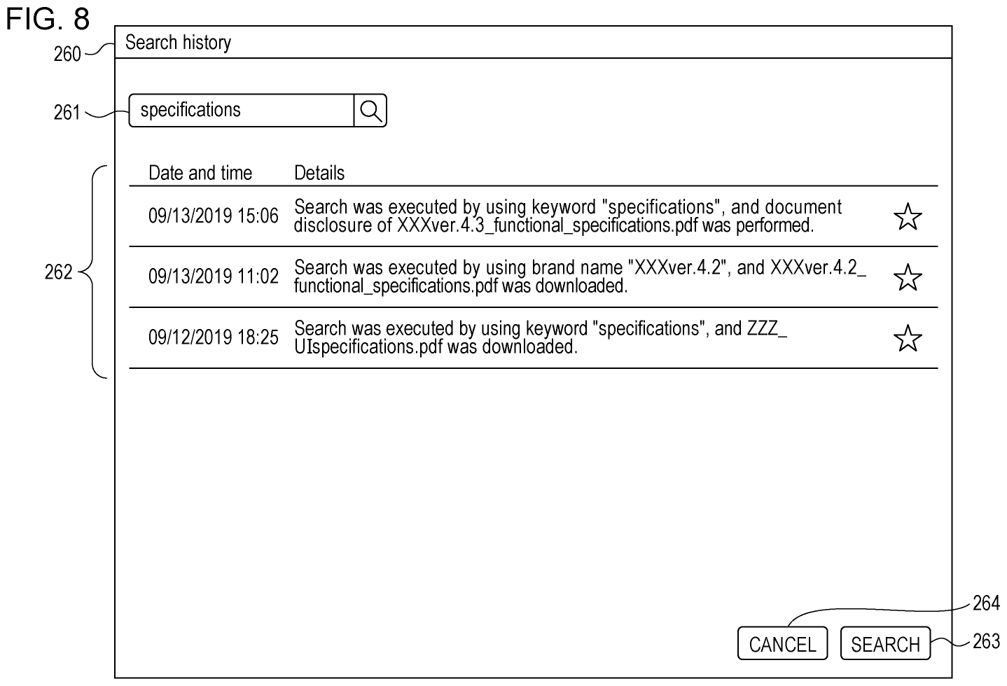

FIG. 8 is a view illustrating the search history display screen 260 displayed after the search history statements are narrowed down. In comparison of search history display screen 260 in FIG. 8 with that in FIG. 7, only the three search history statements 262a, 262b, and 262c matching the setting condition displayed on the search history display screen 260 in FIG. 7 are displayed in the search history statement display area 262 on the search history display screen 260 in FIG. 8.

The exemplary embodiment of the present disclosure has heretofore been described. The technical scope of the present disclosure is not limited to the aforementioned exemplary embodiment. For example, a search history statement generated as a natural language sentence from the search history is displayed in the exemplary embodiment above; however, it suffices that the search history includes the above-described information such as a search condition or the attribute of a file on which an operation was performed. The search history does not necessarily have to be displayed by using the natural language sentence. However, displaying is desirably performed to represent association between the search condition and the attribute of each file on which the operation was performed on a per search basis. A conceivable way of displaying is, for example, displaying, in one line or one frame, the search condition and the attribute of a file that are associated with a search.

In the exemplary embodiment above, only the information regarding one or more data files on which operations were performed among the data files in the search result is included in the search history; however, information regarding one or more data files on which operations were not performed may be included in the search history. In this case, when the search history is displayed, only information regarding data files on which operations were performed may be displayed. In addition, various modifications and configuration replacement are included in the present disclosure without departing from the scope of the technical spirit of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
display a screen for specifying one or more search conditions of a search,
wherein the screen presents one or more search histories, and
wherein each search history of the one or more search histories presents one or more previous search conditions used for a previous search, together with an attribute of a file on which a user performed an operation following the previous search.

2. The information processing apparatus according to claim 1,
wherein the search history further presents a type of the operation performed on the file, in association with the previous search.

3. The information processing apparatus according to claim 1,
wherein the one or more previous search conditions include only a portion of a plurality of previous search conditions used for the previous search.

4. The information processing apparatus according to claim 3,
wherein the one or more previous search conditions include a condition that was changed for the previous search from a default setting.

5. The information processing apparatus according to claim 1,
wherein the search history further presents identification information of a terminal from which the previous search was requested.

6. The information processing apparatus according to claim 1,
wherein the search history further presents identification information of a searcher of the previous search.

7. The information processing apparatus according to claim 5,
wherein the search history further presents identification information of a searcher of the previous search.

8. The information processing apparatus according to claim 2,
wherein the processor is configured not to present, in the search history, the type of the operation performed on the file, if the operation was performed after an elapse of a predetermined time from the previous search.

9. The information processing apparatus according to claim 2,
wherein the processor is configured to present, in the search history, only a most recent operation of a plurality of operations performed on the file following the previous search.

10. The information processing apparatus according to claim 1,
wherein the processor is configured to:
receive one or more narrowing-down conditions for narrowing down the one or more search histories, and
in accordance with the received narrowing-down conditions, narrow down the one or more search histories.

11. The information processing apparatus according to claim 1,
wherein the processor is configured to display an attribute of only a portion of a plurality of files on which a user performed an operation following the previous search.

12. A non-transitory computer readable medium storing a program causing a computer to execute a process comprising:
displaying a screen for specifying one or more search conditions of a search,
wherein the screen presents one or more search histories, and
wherein each search history of the one or more search histories presents one or more previous search conditions used for a previous search, together with an attribute of a file on which a user performed an operation following the previous search.

13. An information processing apparatus comprising:
means for displaying a screen for specifying one or more search conditions of a search,
wherein the screen presents one or more search histories, and
wherein each search history of the one or more search histories presents one or more previous search conditions used for a previous search, together with an attribute of a file on which a user performed an operation following the previous search.
